(19) United States
(12) Patent Application Publication
(10) Pub. No.: US 2005/0235649 A1
(43) Pub. Date: Oct. 27, 2005

(54) Method for operating a gas turbine

(75) Inventors: Joan M. Baer, Casselberry, FL (US); Walter R. Laster, Oviedo, FL (US); Douglas A. Keller, Oviedo, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 11/169,476

(22) Filed: Jun. 29, 2005

Related U.S. Application Data
(63) Continuation-in-part of application No. 10/754,195, filed on Jan. 9, 2004.

(51) Int. Cl. F02C 1/00

(52) U.S. Cl. 60/772; 60/39.5

(57) ABSTRACT

A gas turbine (10) includes a compressor (12) receiving inlet air (18) and producing compressed air, a combustor (14) receiving a combustion portion (30) of the compressed air and producing a hot combustion gas (32), and a turbine (16) receiving the hot combustion gas and producing an exhaust gas (28). The gas turbine also includes a bypass flow path (34) receiving a bypass portion (e.g. 36) of the compressed air and conducting the bypass portion into the exhaust gas to produce a cooled exhaust gas (44). In addition, the gas turbine includes a recirculation flow path (64) receiving a recirculation portion (e.g. 62) of the compressed air and conducting the recirculation portion into the inlet air upstream of the compressor to heat the inlet air.

### CROSS REFERENCE TO RELATED APPLICATIONS

This application is a continuation-in-part of and claims the benefit of the Jan. 9, 2004 filing date of U.S. patent application Ser. No. 10/754,195.

### FIELD OF THE INVENTION

This invention relates generally to the field of power generation, and more particularly, to operation of a gas turbine.

### BACKGROUND OF THE INVENTION

Combined cycle power plants are well known in the art. A combined cycle power plant includes both a gas turbine-based topping cycle and a steam turbine or a steam rankine bottoming cycle that is driven by heat in the exhaust of the gas turbine. During startup of a combined cycle power plant from cold start conditions, the gas turbine portion of the plant necessarily must be started before the steam turbine portion. The term cold start is a relative term but is used herein to refer generally to conditions where the plant has not been operated for an extended time period, such as 48 hours, and where the boiler is not pressurized. During startup of a gas turbine having a single shaft-constant speed arrangement, there is a relatively rapid increase in the flow rate of the exhaust from the gas turbine as it accelerates to operating speed. Thereafter, the exhaust gas flow rate remains relatively constant except for the effect of compressor inlet guide vane modulation. After the gas turbine reaches operating speed, the temperature of the exhaust gas gradually increases as the firing temperature of the gas turbine is increased up to the level required to produce the desired power output. However, the rate of increase in load and temperature of the gas turbine exhaust is constrained by thermal transient stress limits in the components of the steam turbine and the balance of plant, including the heat recovery steam generator (HRSG) that is exposed to the hot exhaust gas stream. During startup, the startup temperature of the gas turbine exhaust is regulated to gradually heat and pressurize the HRSG. In a typical combined cycle plant, the gas turbine may be initially limited to about 20-30% rated power in order to maintain the exhaust at a sufficiently low temperature to maintain stresses within acceptable levels in the cold HRSG.

The necessity to gradually heat a combined cycle power plant during startup reduces the overall efficiency of the plant and reduces the plant's ability to respond to rapidly changing power requirements. Furthermore, the operation of the gas turbine portion of the plant at less than full rated load may result in a level of gaseous emissions that exceeds regulatory or Original Equipment Manufacturers base load contractual requirements. In particular, it is known that the level of carbon monoxide (CO) produced in a gas turbine engine will increase as the firing temperature is decreased during part-load operation. Operation of the gas turbine portion of a combined cycle power plant at 20-50% rated load during the startup phase will often place the plant outside of emissions compliance limits. Not only does such operation have an undesirable impact on the local environment, but it may also have a negative financial impact on the owner or operator of the plant, since a plant revenue stream may be adversely impacted by operation outside of regulatory compliance limits. Accordingly, there is a strong incentive to reduce the startup time for a combined cycle power plant and to reduce the operation of the plant at non-compliance emissions points.

### BRIEF DESCRIPTION OF THE DRAWINGS

The invention will be more apparent from the following description in view of the drawings that show:

FIG. 1 is a functional diagram of a combined cycle power plant having a gas turbine having a flow path conducting compressed air from an inlet upstream of the combustor to an outlet downstream of the turbine.

FIG. 2 is a flow chart illustrating a method of opening inlet guide vanes to provide a flow of compressed air directed downstream of the turbine of FIG. 1.

FIG. 3 is a graph illustrating the gross plant load versus time during the startup of a combined cycle power plant both with and without the use of a bypass flow path.

FIG. 4 is a functional diagram of a combined cycle power plant having a gas turbine comprising a bypass flow path and a recirculation flow path.

### DETAILED DESCRIPTION OF THE INVENTION

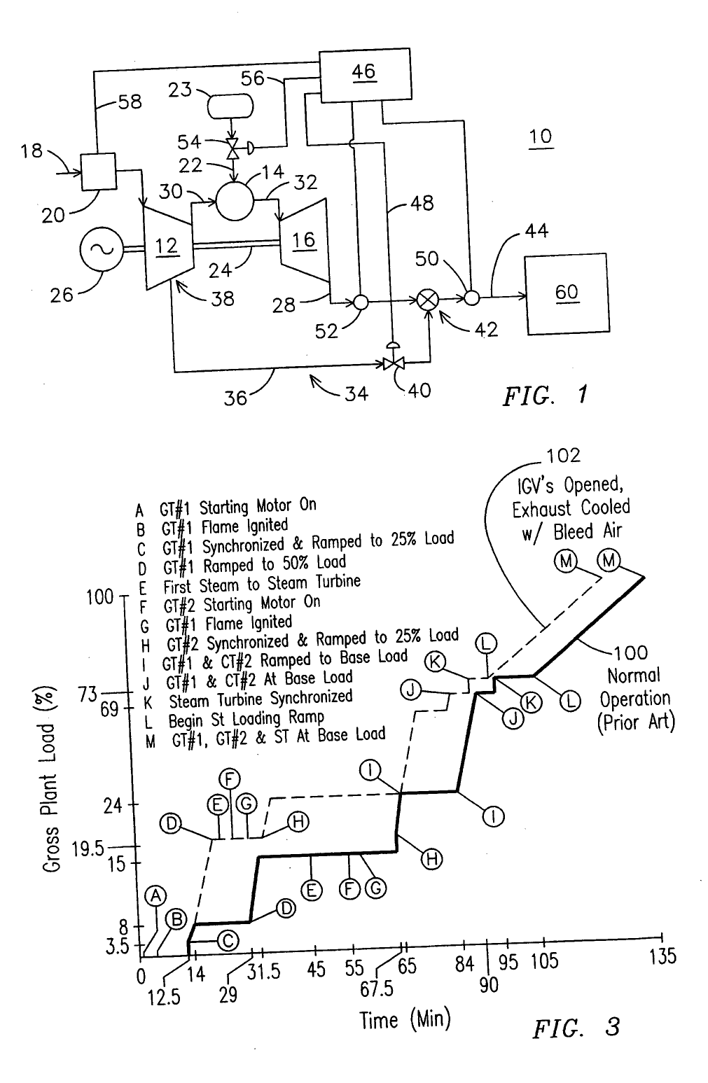

FIG. 1 is a functional diagram of a gas turbine 10. Major component of the gas turbine 10 include a compressor 12, a combustor 14 and a turbine 16. The gas turbine 10 receives ambient air 18 through a set of inlet guide vanes 20. The ambient air 18 is compressed by compressor 12 and delivered to combustor 14 where it is used to combust a flow of fuel 22 from a fuel source 23 to produce hot combustion gas 32. The hot combustion gas 32 is delivered to turbine 16 where it is expanded to develop shaft power. Typically, the turbine 16 and compressor 12 are connected to a common shaft 24, which in turn may be connected to an electrical generator 26. In a combined cycle plant, the exhaust gas 28 produced by the gas turbine 10 may be directed to an HRSG (not shown) of a steam turbine portion 60 of the plant. The aforementioned components of the gas turbine 10 are fairly typical of those found in the prior art, and other known variations of these components and related components may be used in other embodiments of the present invention.

In a conventional startup procedure, the loading on the gas turbine 10 may be limited to 20% to 50% of a rated base load to insure that a sufficiently low exhaust temperature is maintained to avoid overheating a downstream HRSG. However, partial load operation may increase pollutant emission due to a decreased firing temperature inherent when operating at less than full load. In addition, at low loads, stability of the flame may be difficult to achieve as a result of the decreased firing temperature and a comparatively lower air to fuel ratio (AFR) as less fuel is provided per the same air volume that is provided at higher loads. To improve stability of the flame during start up, the inlet guide vanes 20 are typically closed to reduce a volume of ambient air 18 introduced into the compressor 12. Consequently, the compressor 12 supplies a relatively smaller volume of a combustion portion 30 of compressed air compared to a volume of the combustion portion 30 exiting the compressor 12 when the vanes 20 are open. As a result, the AFR in the combustor 14 may be lowered, provided a volume of fuel 23 supplied to the combustor 14 is maintained. Therefore, in conventional gas turbines, the inlet guide vanes 20 are closed during startup to provide a lower AFR and achieve flame stability at partial loads. As a load on the gas turbine 10 is increased (for example, according to a desired loading schedule for gas turbine startup in a combined cycle plant), the inlet guide vanes 20 may be gradually opened until reaching a fully open position at a predetermined power level.

Contrary to the conventional technique of closing the inlet guide vanes during a startup period, the inventors have developed an innovative gas turbine operating method that includes opening, instead of closing, the inlet guide vanes during startup. Opening the inlet guide vanes has the advantage of increasing the temperature of air exiting the compressor, and consequently, a firing temperature in the combustor to achieve flame stability and reduced CO formation. However, with the inlet guide vanes being opened, the compressor will provide a greater volume of compressed air than is a volume of compressed air needed to support combustion in the combustor. An excess volume of compressed air, comprising, for example, a portion of the greater volume of compressed air exceeding the volume of compressed air needed to support combustion, is extracted upstream of the combustor and directed downstream of the turbine to combine with the turbine exhaust. Accordingly, an overall exhaust temperature of the gas turbine may be reduced by addition of excess air having a temperature relatively lower than a temperature of the exhaust gas exiting the turbine. As a result, the firing temperature (power level) may be maintained at a higher temperature (power) because the exhaust from the turbine is cooled, for example, to a temperature low enough to prevent damage to a downstream HRSG. Advantageously, the gas turbine 10 may be operated at a power level sufficiently high to enable satisfying an emissions regulation by combining the excess compressed air with the exhaust gas. In addition, the gas turbine 10 may be scheduled to operate at a higher load relatively sooner than is possible in a conventional combined cycle plant.

To accomplish the foregoing, the gas turbine 10 further includes a bypass flow path 34 conducting an excess portion 36 of the compressed air from an inlet 38 upstream of the combustor 14 to an outlet 42 downstream of the turbine 16. In one embodiment, the excess portion 36 may be extracted from inlet 38 positioned in an early stage of compressor 12 for providing a comparatively cooler, lower pressure excess portion 36 than may be available in a later stage of the compressor. For example, in a compressor 12 having stages numbering 1 through N, consecutively, from a lowest pressure stage to a highest pressure stage, the inlet 38 may be disposed in a stage having a stage number less than N/2. In a 19-stage compressor, the inlet 38 may be disposed in the 6^{th} stage. Extracting excess portion 36 from a lower pressure stage may be desired to minimize the pressure of the excess portion 36 entering the exhaust gas 28. In a retrofit application, the excess portion 36 may be extracted from a preexisting pressure tap, such as a bleed port in the compressor 12, thereby reducing the need for extensive modifications.

The bypass flow path 34 may further include an excess air control valve 40, such as a metering valve, for controlling the amount of excess portion 36 bypassed around the combustor 14 and turbine 16. The excess air control valve 40 may be metered to deliver a controlled amount of excess portion 36 into exhaust gas 28 downstream of the turbine 16 to produce a cooled exhaust 44. Accordingly, cooled exhaust 44 has a higher mass and a lower temperature than does the flow of exhaust gas 28 leaving the turbine 16. The excess air control valve 40 may be responsive to a valve control signal 48 provided by a controller 46. The valve controller 46 may control the excess air control valve 40 in response to temperature measurements provided by temperature sensor 52 for measuring a temperature of the exhaust gas 28 and temperature sensor 50 for measuring a temperature of the cooled exhaust 44. For example, in a retrofit application, an existing gas turbine controller may be modified to incorporate monitoring temperatures of the exhaust gas 28 and cooled exhaust 44 to generate a valve control signal 48 controlling the flow of the excess portion 36 into the exhaust gas 28. In addition, other system parameters that are useful in controlling gas turbine operation, such as temperatures, pressures, or flow rates at other locations throughout the combined cycle plant, may be sensed by the controller 46 to generate a desired flow of excess portion 36 into the exhaust gas 28 via excess air control valve 40. In other retrofit applications, temperature sensor 50 may need to be installed in the flow of cooled exhaust 44 downstream from a point where the excess portion 36 is combined with the exhaust gas 28.

The controller 46 may be further configured to control an amount of fuel provided to the combustor 14 via a fuel metering valve 54. For example, the flow of fuel 22 provided to the combustor 14 may be controlled to achieve a desired combustion condition, such as a desired firing temperature, or air to fuel ratio in the combustor 14. The flow of fuel 22 may be adjusted depending on an amount of excess portion 36 bypassed around the combustor 14 and turbine 16 and the amount of air 30 provided to the combustor 14. In addition, the controller 46 may be configured to control the position of the inlet guides vanes 20, via an inlet guide vanes control signal 58, for example, in conjunction with an amount of excess portion 36 directed around the combustor 12 and turbine 16. In an aspect of the invention, the inlet guide vanes 20 may be fully opened during start initiation, and the position of the vanes 20 adjusted after start initiation according to an amount of excess portion 36 bypassed. Accordingly, a desired operating condition, such as a desired air to fuel ratio in the combustor 14, may be achieved. In yet another aspect, the inlet guide vanes 20 may be controlled in response to the exhaust gas temperature.

FIG. 2 is a flow chart 70 illustrating an exemplary control method for opening the inlet guide vanes 20 to provide a flow of excess portion 36 directed downstream of the turbine of FIG. 1. In one form, the controller 46 may be configured to perform the actions shown in the flow chart 70. The control method may be initiated when the gas turbine 10 reaches a loading of 25% of a rated base load 72. The inlet guide vanes 20 are opened 74 from their normally closed position to allow a larger volume of air to enter the compressor 12 than is conventionally supplied. For example, the inlet guide vanes 20 may be opened to a maximum opened position, such as 0 degrees with respect to an incoming air flow. Excess portion 36 is then extracted 76 from the compressor 12 and injected 78 downstream of the turbine 16. To maintain a desired firing temperature in the combustor 14, the flow of fuel 22 may be increased 80 in response to an increased volume of air flowing through the combustor as a result of opening the inlet guide vanes 20. The amount of excess portion 36 bypassed around the combustor 14 and turbine 16 may be adjusted 82, for example, in a combined cycle system, to maintain a desired HRSG temperature curve. The flow of fuel 22 is then adjusted to maintain a desired firing temperature responsive to a temperature of the exhaust gas 28, until the steam portion of the turbine 60 is brought up to full load. If the steam turbine portion 60 has not reached full load 86, then the amount of excess portion 36 and the flow of fuel 22 are continually adjusted 82, 84, if required. Once the steam turbine portion 60 has reached full load, the excess air control valve 40 is closed 88 and normal gas turbine 10 operation is resumed 90.

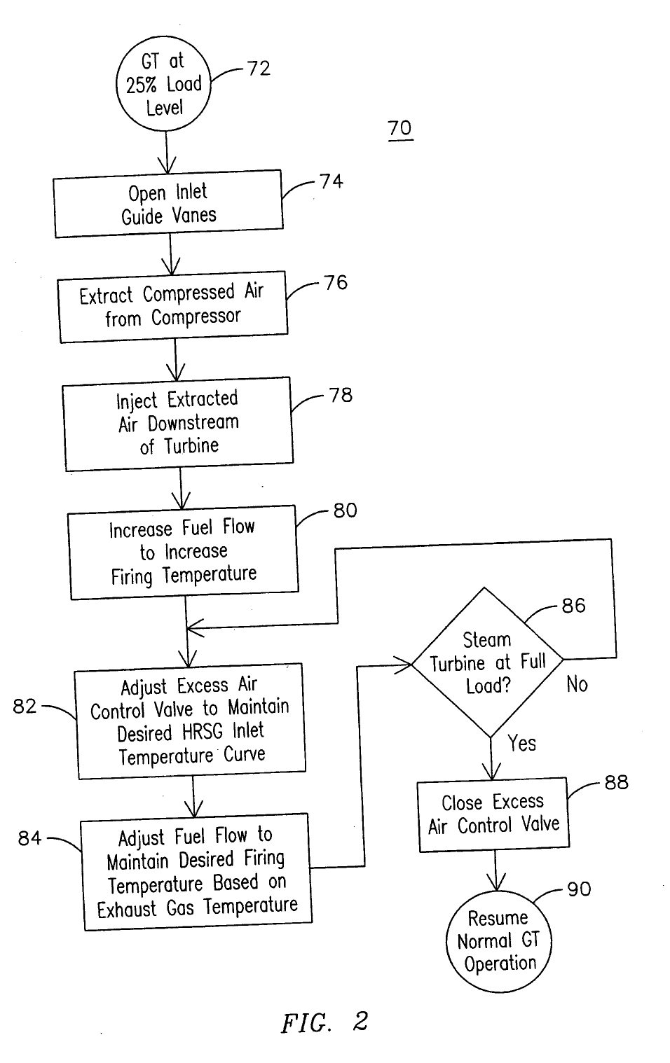

The startup of an exemplary combined cycle power plant having dual gas turbines, GT 1 and GT 2, both with and without the use of a bypass flow path 34, is illustrated in FIG. 3. Curve 100 shows the power output versus time using prior art procedures and equipment, while curve 102 shows power output versus time with the bypass flow path 34 activated and using the procedure described herein. The plant is started from shutdown conditions by first starting GT 1. The power level of GT 1 is increased to a level above that which would otherwise be possible without the use of bypass flow path 34, and preferably is increased as rapidly as possible to a power level where all emissions in the gas turbine exhaust are at their lowest levels or at a desired low level (on a ppm basis) for satisfying emissions regulations. During this time, the temperature of the cooled exhaust 44 into the steam turbine portion 60 is kept within acceptable levels by the relatively cooler excess portion 36. During this period, the excess air control valve 40 is metered to provide an appropriate flow of excess portion 36 to combine with the exhaust gas 28 so that the temperature of the cooled exhaust 44 does not exceed that which is acceptable for warming of an HRSG in the steam turbine portion 60 and that which is used for startup under prior art procedures.

Accordingly, GT 1 and GT 2 may operated at higher loads with correspondingly reduced emissions, sooner than is possible over the prior art (as can be seen by comparing respective operating points at D and J, for example). In the example of FIG. 3, the total plant startup time to full power is reduced from about 95 minutes to about 88 minutes, and the total power generated by the plant during the startup phase is increased by about one quarter (area under the respective curves) with use of the bypass flow path 34. Importantly, the gas turbine portion 10 can be operated at a power level sufficiently high so that the gas turbine exhaust emissions are at a desired low level at or close to their lowest concentration levels measured on a ppm basis. These lower emissions levels allow the operator to satisfy regulatory and contractual emissions commitments, thereby potentially further increasing the revenue generated by the plant and providing a reduced environmental impact.

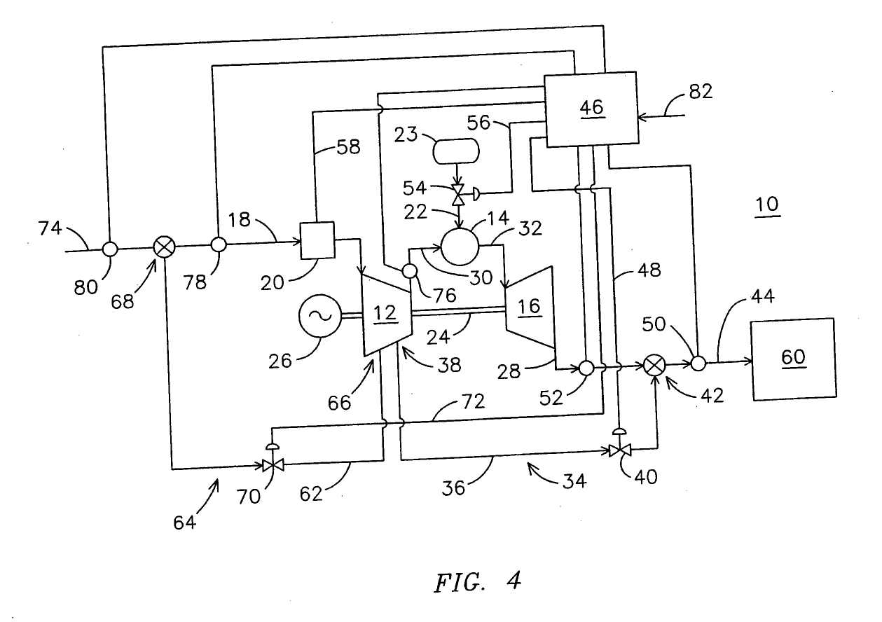

In another aspect of the invention shown in FIG. 4, a recirculation portion 62 of the compressed air 12 may be extracted from the compressor 12 and combined with inlet air 18 upstream of the compressor 12 to heat the inlet air 18. To generate the recirculation portion 62, a volume of the inlet air 18 provided to the compressor 12 may be increased sufficiently to allow the compressor 12 to produce a volume of compressed air 12 exceeding a volume of compressed air needed to support combustion. For example, controlling a position of the inlet guide vanes 20 may control the volume of the inlet air 18 provided to the compressor 12. The recirculation portion 62 of the compressed air 12 produced, but not needed to support combustion, may then be extracted from the compressor 12 and combined with inlet air 18 upstream of the compressor 12. As is understood in the art, compressing a gas increases the temperature of the gas. Accordingly, as a result of compression, the recirculation portion 62 will have a higher temperature than ambient air 38 entering the compressor. By combining the relatively warmer recirculation portion 62 with the relatively cooler ambient air 38 to heat the inlet air 18, a higher temperature compressed air 30 may be provided than would be possible without combining the recirculation portion 62 with the ambient air 38. Therefore, an increased firing temperature within the combustor 14 may be achieved due to the higher temperature of the compressed air 30, thereby reducing, for example, CO emissions.

To accomplish the foregoing, the gas turbine 10 may further include a recirculation flow path 64 for conducting the recirculation portion 62 from a recirculation inlet 66 upstream of the combustor 14 to a recirculation outlet 68 upstream of the compressor 12, such as upstream of the inlet guides vanes 20. In one embodiment, the recirculation portion 62 may be extracted from a late stage of compressor 12 to provide a comparatively higher temperature recirculation portion 62 than may be available by extraction from an earlier stage. For example, in a compressor 12 having stages numbering 1 through N, consecutively, from a lowest pressure stage to a highest pressure stage, the recirculation portion 62 may be extracted from a stage having a stage number greater than N/2. In a retrofit application, the recirculation portion 62 may be extracted from a preexisting bleed port in the compressor 12, thereby reducing the need for extensive modifications. In another embodiment, the recirculation portion 62 may be extracted from the compressor shell (not shown). In yet another embodiment, the inlet 38 of the bypass flow path 34 and the inlet 66 of the recirculation flow path 64 comprise a single outlet from the compressor 12.

The recirculation flow path 64 may further include a recirculation control valve 70, such as a metering valve, for controlling the amount of recirculation air 62 directed into the inlet air 18. The recirculation control valve 70 may be metered, for example, to maintain a desired temperature of the inlet flow 18 to achieve a desired temperature of the compressed air 30 entering the combustor 14. The recirculation control valve 70 may be responsive to a recirculation control signal 72 provided by the controller 46. The controller 46 may control the recirculation control valve 70, for example, in response to a temperature of the compressed air 30, a temperature of the exhaust gas 28, a temperature of the inlet air 18, and/or a temperature of ambient air 74, measured by respective temperature sensors 76, 52, 78, 80. In addition, other system parameters, such as temperatures, pressures, or flow rates at other locations throughout the system, may be sensed by the controller 46 to control the amount of recirculation air 62 combined with the inlet air 18 by controlling the recirculation control valve 70. In another aspect of the invention, the controller 46 may receive a signal 82 indicative of a load on the gas turbine 10, such as a load signal produced by the generator 26.

The controller 46 may be further configured to control an amount of fuel 23 provided to the combustor 14 via the fuel metering valve 54 responsive, for example, to an amount of the bypass portion 32 directed around the combustor 14 and turbine 16, and/or an amount of the recirculation air 62 recirculated back into the compressor 12. For example, the flow of fuel 22 provided to the combustor 14 may be controlled to achieve a desired combustion condition, such as a desired firing temperature or AFR in the combustor 14. In an embodiment, the flow of fuel 22 may be controlled in response to a changing volume of inlet air 18 provided to the combustor as a result of changing a position of the inlet guide vanes 20.

In another embodiment, the controller 46 may be configured to control the position of the inlet guides vanes 20, via an inlet guide vane control signal 58, for example, in conjunction with an amount of bypass air flow 36 diverted around the combustor 14 and turbine 16 and/or an amount of recirculation flow 62 recirculated back into the compressor 12. Accordingly, a desired operating condition, such as a desired AFR in the combustor 14 for reducing a CO emission, may be achieved. For example, the inlet guide vanes 20 may be opened during a system startup period to allow the gas turbine 10 to be operated at a higher power while cooling the exhaust gas 28 sufficiently to avoid damage to the downstream steam turbine portion 60. In an aspect of the invention, the controller 46 may be configured to perform the actions shown in the flow chart 70 of FIG. 2, with the addition of recirculating the recirculation portion 62 of the extracted air upstream of the compressor 12 to heat the inlet air 18. For example, a step of recirculating the recirculation portion 62 may be included as a step before, or after, step 78, to heat the inlet air 18 to achieve a desired reduced gas turbine 10 start-up time in conjunction with cooling the exhaust gas 28 with the bypass portion 36 to maintain a sufficiently cooled exhaust 44.

In another aspect of the invention, the inlet guide vanes 20 may be closed and the recirculation portion 62 combined with the compressor inlet air 18 in response, for example, to a reduced power level demand on the gas turbine 10 less than a base load power demand. Closing the inlet guide vanes 20 and heating the inlet air 18 with the recirculation portion 62 may provide an exhaust temperature sufficiently high to generate a desired heat output for the downstream turbine portion 60. As a result of combining the recirculation portion 62 with the inlet air 18, the gas turbine 10 is able to produce an exhaust gas 28 that is hotter than would be produced without using the recirculation portion 62. During a reduced power operation period, the recirculation portion 62 may be controlled to achieve a desired elevated temperature of the inlet air 18 to ultimately achieve a hotter exhaust gas 28. In addition, the bypass portion 36 may be controlled to achieve a desired temperature of the cooled exhaust gas 44, such as by increasing or decreasing an amount of the bypass portion 36 added to the exhaust gas 28 to regulate a temperature of the cooled exhaust gas 44.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A gas turbine comprising:
a compressor receiving inlet air and producing compressed air;
a combustor receiving a combustion portion of the compressed air and producing a hot combustion gas;
a turbine receiving the hot combustion gas and producing an exhaust gas;
a bypass flow path receiving a bypass portion of the compressed air and conducting the bypass portion into the exhaust gas to produce a cooled exhaust gas; and
a recirculation flow path receiving a recirculation portion of the compressed air and conducting the recirculation portion into the inlet air upstream of the compressor to heat the inlet air.

2. The gas turbine of claim 1, further comprising an inlet guide vane disposed upstream of the compressor for controlling an amount of the inlet air received by the compressor.

3. The gas turbine of claim 1, further comprising:
a bypass metering valve, responsive to a bypass valve control signal, positioned in the bypass flow path; and
a recirculation metering valve, responsive to a recirculation valve control signal, positioned in the recirculation flow path.

4. The gas turbine of claim 3, further comprising a controller for generating the bypass valve control signal and the recirculation valve control signal responsive to an operating condition of the gas turbine.

5. The gas turbine of claim 4, wherein the operating condition comprises an engine load.

6. The gas turbine of claim 1, wherein the compressor comprises stages numbering 1 through N consecutively from a lowest pressure stage to a highest pressure stage, an inlet of the bypass flow path disposed in a stage having a stage number less than N/2.

7. The gas turbine of claim 6, wherein the inlet of the bypass flow path comprises a pressure tap port on the compressor.

8. The gas turbine of claim 1, wherein the compressor comprises stages numbering 1 through N consecutively from a lowest pressure stage to a highest pressure stage, an inlet of the recirculation flow path disposed in a stage having a stage number less than N/2.

9. The gas turbine of claim 8, wherein the inlet of the recirculation flow path comprises a pressure tap port on the compressor.

10. The gas turbine of claim 1, wherein an inlet of the bypass flow path and an inlet of the recirculation flow path comprise a single outlet from the compressor.

11. A method of operating a gas turbine comprising a compressor, a combustor, and a turbine, the method comprising:
controlling a volume of inlet air provided to a compressor of a gas turbine to allow the compressor to produce a volume of compressed air exceeding a volume of compressed air needed to support combustion; and
extracting a recirculation portion of the compressed air produced but not needed to support combustion and combining the recirculation portion with inlet air to heat the inlet air.

12. The method of claim 11, wherein controlling the volume of inlet air provided to the compressor comprises opening an inlet guide vane disposed upstream of the compressor.

13. The method of claim 12, further comprising extracting a bypass portion of the compressed air produced but not needed to support combustion and combining the bypass portion with an exhaust gas generated by the turbine to produce a cooled exhaust gas.

14. The method of claim 11, wherein controlling the volume of inlet air provided to the compressor comprises closing an inlet guide vane disposed upstream of the compressor responsive to a power demand on the gas turbine less than a base load power demand.

15. The method of claim 14, further comprising extracting a bypass portion of the compressed air produced but not needed to support combustion and combining the bypass portion with an exhaust gas generated by the turbine to control an exhaust gas temperature.

16. A method of operating a combined cycle power plant having a gas turbine portion and a steam turbine portion, the method comprising:
operating a gas turbine of a gas turbine portion of a combined cycle power plant at a power level that produces hot exhaust gas at a temperature greater than a temperature desired for warming the steam turbine portion;
combining a recirculation portion of an excess portion of compressed air produced by a compressor of the gas turbine with compressor inlet air to produce heated inlet air;
combining a bypass portion of the excess portion with the hot exhaust gas to cool the exhaust gas to the temperature desired for warming the steam turbine portion; and
delivering the cooled exhaust gas to the steam turbine portion.

17. A method of operating a combined cycle power plant having a gas turbine portion and a steam turbine portion, the method comprising:
combining a recirculation portion of an excess portion of compressed air produced by a compressor of a gas turbine of a gas turbine portion of a combined cycle power plant with compressor inlet air to heat the inlet air;
operating the gas turbine at a reduced power level less than a base load power level so that the gas turbine produces a hot exhaust gas that is hotter than would be produced without combining the recirculation portion with the compressor inlet air; and
delivering the exhaust gas to the steam turbine portion.

18. The method of claim 17, further comprising combining a bypass portion of the excess portion with the hot exhaust gas to produce a cooled exhaust gas.
